(19) United States
(12) Patent Application Publication
(10) Pub. No.: US 2026/0155265 A1
(43) Pub. Date: Jun. 4, 2026

(54) ORDERED PARTICLE FUEL

(71) Applicant: ULTRA SAFE NUCLEAR CORPORATION, Seattle, WA (US)

(72) Inventors: Tom HINKLIN, Sandy, UT (US); Vishal PATEL, Seattle, WA (US); Ethan CHALEFF, Groveland, CA (US); Michael John EADES, Seattle, WA (US); Kurt A. TERRANI, Knoxville, TN (US)

(73) Assignee: Standard Nuclear, Inc., Oak Ridge, TN (US)

(21) Appl. No.: 19/122,564

(22) PCT Filed: Sep. 8, 2023
(86) PCT No.: PCT/US2023/032247

§ 371 Date: Apr. 18, 2025

Related U.S. Application Data
(60) Provisional application No. 63/405,143, filed on Sep. 9, 2022.

(51) Int. Cl. G21C 3/32; B33Y 10/00; B33Y 40/20; B33Y 80/00; G21C 3/04; G21C 3/07; G21C 3/16

(52) U.S. Cl. CPC G21C 3/32; G21C 3/042; G21C 3/07; G21C 3/16; B33Y 10/00; B33Y 40/20; B33Y 80/00

(57) ABSTRACT

A fuel element with an ordered particle fuel particle packing to improve lifetime and retention. The fuel element includes an encapsulation matrix and a plurality of coolant channels formed in the encapsulation matrix. Fuel element further includes a plurality of fuel particle matrices disposed within the encapsulation matrix. Each of the fuel particle matrices is ordered in a vertically aligned geometry or a twisted geometry to: (a) substantially laterally surround a contour of a respective coolant channel, and (b) orient substantially longitudinally or substantially helically along the respective coolant channel. For example, each of the fuel particle matrices can include a plurality of fuel particles that are a cluster around the respective coolant channel. The encapsulation matrix can be a high-temperature matrix. A fabrication method for the fuel element includes three-dimensional printing the fuel element and placing the plurality of fuel particles in selected locations in the fuel element.

### CROSS-REFERENCE TO RELATED APPLICATIONS

This application claims priority to U.S. Patent Provisional Application No. 63/405,143, filed on Sep. 9, 2022, titled “Ordered Particle Fuel,” the entirety of which is incorporated by reference herein. This application relates to International Application No. PCT/US2023/XXXXXX, filed on Sep. 8, 2023, titled “Spiral NTP Fuel for Power Flattening,” the entirety of which is incorporated by reference herein.

### TECHNICAL FIELD

The present subject matter relates to examples of nuclear reactor systems and nuclear reactors for power production and propulsion, e.g., in remote regions, such as outer space. The present subject matter also encompasses a nuclear fuel element that includes ordered fuel particles.

### BACKGROUND

The performance of nuclear thermal propulsion (NTP), as well as other extremely high-temperature nuclear heating applications is directly related to the maximum temperature of the coolant (e.g., propellant). For example, in NTP, the thrust efficiency (e.g., specific impulse (Isp)) is directly related to the ultimate temperature achieved of the coolant.

In NTP, for example, exhaust temperatures greater than 2,700 Kelvin (K) are desired (e.g., for interplanetary travel), which puts a significant limit on the types of materials that are acceptable. If exhaust temperatures exceed 2,700 K, then the fuel bearing material will necessarily become even hotter. Because most materials are unstable at temperatures exceeding 2,700 K and conditions of flowing a coolant (e.g., hydrogen (H₂)), the amount of temperature over 2,700 K directly affects fuel rod lifetimes and fission product retention in a nuclear reactor core. Accordingly, improvements to fuel elements for the nuclear reactor core are needed.

### SUMMARY

A fuel element 104 implements ordered particle fuel, such as an ordered fuel particle packing 157, to optimize heat transfer. Ordered fuel particle packing 157 minimizes the transport distance of heat generated by fuel particles 151A-N to coolant (e.g., propellant) flowing in a coolant channel 141. The ordered fuel particle packing 157 keeps the fuel particles 151A-N and an encapsulation matrix 152 of the fuel element 104 as cool as possible by having a thermal diffusion distance to the coolant channel 141 and exhaust as small as possible-a minimal thermal diffusion distance.

In contrast, in a random fuel particle packing 158, the fuel particles 151A-N are typically randomly placed in a fuel element 104 relative to the propellant. Hence, in the random fuel particle packing 158 any fuel particles 151A-N that are not at the minimum thermal diffusion distance to the coolant channel 141 are hotter than needed and decompose more quickly than those at the minimum thermal diffusion distance.

Ordered fuel particle packing 157 reduces peak fuel temperature, keeping all other things constant, by more than 150 Kelvin. Given the number of exponential diffusion and interaction potentials with temperature, a 150 Kelvin reduction in temperature increases lifetime and retention of the fuel element 104 by approximately an order of magnitude.

Use of the ordered fuel particle packing 157 as opposed to a random fuel particle packing 158 also allows for the better prediction of stress and mitigation of failure mechanisms. By ordering and arranging uranium bearing material in a fuel element 104, the stress states can be discretized and analyzed. In a randomly packed fuel that implements the random fuel particle packing 158, the stress state can be indeterminate. By specifying the fuel placement in a geometry with the ordered fuel particle packing 157, the reliability, lifetime, and retention of the fuel element 104 are more accurately predicted.

An example fuel element 104 that implements the ordered fuel particle packing 157 includes an encapsulation matrix 152 and a plurality of coolant channels 141A-N formed in the encapsulation matrix 152. The fuel element 104 further includes a plurality of fuel particle matrices 111A-N disposed within the encapsulation matrix 152. Each of the fuel particle matrices 111A-N is: ordered in a vertically aligned geometry 155 or a twisted geometry 156 to: (a) substantially laterally surround a contour of a respective coolant channel 141A-N, and (b) orient substantially longitudinally or substantially helically along the respective coolant channel 141A-N.

An example ordered particle fuel fabrication method 1000 for the fuel element 104 includes three-dimensional printing a green body 199 of the fuel element 104 to form the plurality of coolant channels 141A-N. The ordered particle fuel fabrication method 1000 further includes placing the plurality of fuel particles 151A-N in selected locations in the fuel element 104.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1 is a cross-sectional view of a nuclear reactor core of a nuclear reactor system that includes fuel elements with an ordered fuel particle packing.

FIG. 2 is a zoomed in view of the nuclear reactor core of FIG. 1 showing details of a single fuel element that includes coolant channels and fuel particle matrices with the ordered fuel particle packing.

FIG. 3A is a cutaway view of a single fuel element similar to that of FIG. 2 that depicts a fuel particle matrix with the ordered fuel particle packing in a vertically aligned geometry.

FIG. 3B is a zoomed in view of a detail area of the fuel element of FIG. 3A with the fuel particle matrix ordered in the vertically aligned geometry.

FIG. 4A is a cutaway view of a single fuel element similar to that of FIG. 2 that depicts a fuel particle matrix with the ordered fuel particle packing in a twisted geometry.

FIG. 4B is a zoomed in view of a detail area of the fuel element of FIG. 4A with the fuel particle matrix ordered in the twisted geometry.

FIG. 5 is an isometric view of a single fuel element similar to that of FIGS. 4A-B and showing details of the coolant channels helically winding around a longitudinal axis.

FIG. 6A is a cross-sectional view of a single fuel element similar to that of FIGS. 2A-B and 3A-B showing details of coolant channels and fuel particle matrices.

FIG. 6B is a cross-sectional view of a fuel element like that of FIGS. 3A-B and 4A-B with an ordered fuel particle packing in which the fuel particle matrix has a laterally nested geometry.

FIG. 7A is an isometric view of a green form of a single fuel element that includes coolant channels.

FIG. 7B is a top view of the green form of FIG. 7A showing details of the coolant channels.

FIG. 7C is a cutaway view of the green form of FIGS. 7A-B showing details of a green form with a twisted geometry.

FIG. 7D is a top view of a single coolant channel of the green form of FIGS. 7A-C.

FIG. 8A is a diagram of the maximum temperature slice for a fuel element with an ordered fuel particle packing.

FIG. 8B is a diagram of the maximum temperature slice for a fuel element with a random fuel particle packing.

FIG. 9A is a diagram of the maximum temperature gradient slice for a fuel element with an ordered fuel particle packing.

FIG. 9B is a diagram of the maximum temperature gradient slice for a fuel element with a random fuel particle packing.

FIG. 10 is a flowchart of an ordered particle fuel fabrication method for a fuel element.

### PARTS LISTING

100 Nuclear Reactor System
101 Nuclear Reactor Core
102A-N Insulator Elements
103A-N Moderator Elements
104A-N Fuel Elements
107 Nuclear Reactor
111A-N Fuel Particle Matrices
112 Insulator Element Array
113 Moderator Element Array
114 Fuel Element Array
115A-N Control Drums
116 Reflector Material
117 Absorber Material
135A-N Control Drum Channels
140 Reflector
141A-N Coolant Channels
145 Longitudinal Axis
146 Lateral Axis 151A-N Fuel Particles
152 Encapsulation Matrix (e.g., High-Temperature Matrix)
153 Helical Shape
154 Straight Shape
155 Vertically Aligned Geometry
156 Twisted Geometry
157 Ordered Fuel Particle Packing
158 Random Fuel Particle Packing
160 Pressure Vessel
181 Cluster
182 Population Number
183 Population Density
191A-H Fuel Particle Arrays
192A-N Longitudinal Levels (e.g., Axial Positions)
193 Height
194A-H Fuel Particle Distribution Stacks
195 Lateral Distance
197 Laterally Nested Geometry
198 Ablation Layer
199 Green Form (e.g., Green Body)
800A-B Maximum Temperature Slice Diagrams
900A-B Maximum Temperature Gradient Slice Diagrams
1000 Ordered Particle Fuel Fabrication Method

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical, physical, or electrical connection. Unless described otherwise, coupled elements or devices are not necessarily directly connected to one another and may be separated by intermediate components, elements, etc.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” or “substantially” mean that the parameter value or the like varies up to ±25% from the stated amount. When used in connection with comparing two or more parameter values, the term “substantially uniform” means the parameter values vary up to ±25% from each other. When used in connection with a direction, “substantially longitudinally” means generally vertical to a point of reference, for example, in a substantially orthogonal or perpendicular direction that is 81°-99° to the point of reference. When used in connection with a direction, “substantially laterally” means generally horizontal to a point of reference, for example, in a substantially sideways or parallel direction, that is 162°-198° to the point of reference. When used in connection with a direction, “substantially helically” means generally turning around a point of reference.

Although A is the first letter of the alphabet and Z is the twenty-sixth letter of the alphabet, due to the restriction of the alphabet, the designation “A-N” when following a reference number, such as 102, 104, 111, 141, 151, etc. can refer to more than twenty-six of those identical elements.

The orientations of the nuclear reactor system 100, nuclear reactor core 101, nuclear reactor 107, fuel elements 104A-N, fuel particle matrices 111A-N, coolant channels 141A-N, associated components, and/or any nuclear reactor system 100 incorporating an ordered fuel particle packing 157, such as shown in any of the drawings, are given by way of example only, for illustration and discussion purposes. In operation for a particular nuclear reactor system 100, the components may be oriented in any other direction suitable to the particular application of the nuclear reactor system 100, for example upright, sideways, or any other orientation. Also, to the extent used herein, any directional term, such as lateral, longitudinal, up, down, upper, lower, top, bottom, and side, are used by way of example only, and are not limiting as to direction or orientation of any nuclear reactor system 100 or component of the nuclear reactor system 100 constructed as otherwise described herein. Reference now is made in detail to the examples illustrated in the accompanying drawings and discussed below.

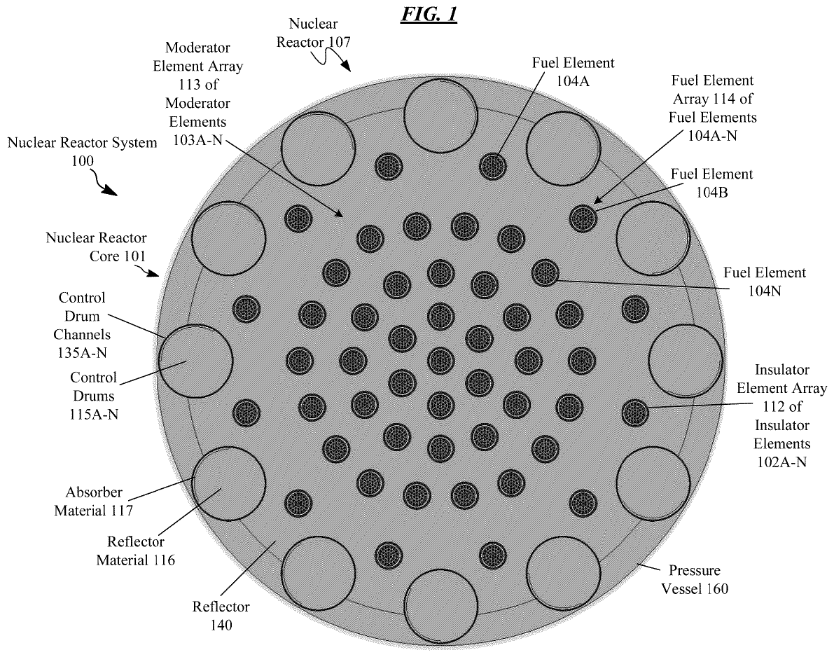

FIG. 1 is a cross-sectional view of a nuclear reactor core 101 of a nuclear reactor system 100 that includes fuel elements 104A-N with the ordered fuel particle packing 157. Nuclear reactor system 100 includes a nuclear reactor 107. Fuel elements 104A-N in the nuclear reactor core 107 implement the ordered fuel particle packing 157 to enable the nuclear reactor 107 to operate where the nuclear fuel operates as close as possible to the maximum possible temperature it can survive during normal operation.

Nuclear reactor 107 includes the nuclear reactor core 101, in which a controlled nuclear chain reaction occurs, and energy is released. The neutron chain reaction in the nuclear reactor core 101 is critical—a single neutron from each fission nucleus results in fission of another nucleus—the chain reaction must be controlled.

By sustaining controlled nuclear fission, the nuclear reactor system 100 produces heat energy. In an example implementation, the nuclear reactor system 100 is implemented as a gas-cooled nuclear reactor 107 where coolant is a gas to achieve performance gains. The ordered fuel particle packing 157 technology can also enable breakthrough performance in other thermal spectrum nuclear reactor systems 100, including large utility scale reactors, heat pipe reactors, and molten-salt-cooled reactors.

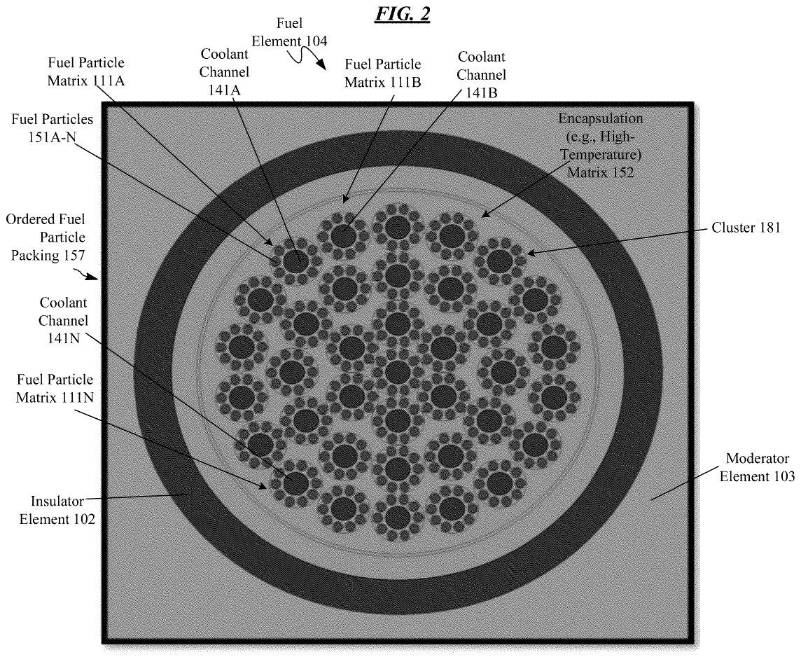

In the depicted example, the nuclear reactor system 100 with the nuclear reactor core 101 is utilized in a space environment, such as in a nuclear thermal propulsion (NTP) system. An example NTP system that the ordered fuel particle packing 157 of the nuclear reactor core 101 can be implemented in is described in FIGS. 1-2 and the associated text of U.S. Pat. No. 10,643,754 to Ultra Safe Nuclear Corporation of Seattle, Washington, issued May 5, 2020, titled “Passive Reactivity Control of Nuclear Thermal Propulsion Reactors” the entirety of which is incorporated by reference herein. In another example, the nuclear reactor system 100 with the nuclear reactor core 101 is utilized in a space reactor for electrical power production on a planetary surface.

Conventional space reactor designs typically utilize highly-enriched uranium (HEU) fuel (weapons grade) to have both low-mass and high-temperature output. The architecture for the nuclear reactor core 101 described herein can use HEU fuel, but is directly applicable to enabling the development of low-mass, high-temperature, low-enriched uranium (LEU) fueled (non-weapons grade) nuclear reactors to increase efficiency and can be designed specifically for space applications. For example, the nuclear reactor system 100 that includes the nuclear reactor core 101 can be a nuclear thermal rocket reactor, nuclear electric propulsion reactor, Martian surface reactor, or lunar surface reactor.

In such an NTP system (e.g., compact space nuclear reactor), a generated thrust propels a vehicle that houses, is formed integrally with, connects, or attaches to the nuclear reactor core 101, such as a rocket, drone, unmanned air vehicle (UAV), aircraft, spacecraft, missile, etc. Typically, this is done by heating a propellant, typically low molecular weight hydrogen, to over 2,600° Kelvin by harnessing thermal energy from the nuclear reactor core 101. In addition, the NTP nuclear reactor system 100 can be used in the propulsion of submarines or ships.

As noted above, the nuclear reactor system 100 can also be a nuclear power plant in a terrestrial land application, e.g., for providing nuclear power (e.g., thermal and/or electrical power) for remote region applications, including outer space, celestial bodies, planetary bodies, and remotes regions on Earth. An example terrestrial land nuclear reactor system that the ordered fuel particle packing 157 of the nuclear reactor core 101 can be implemented in is described in FIG. 1A and the associated text of U.S. Pat. No. 11,264,141 to Ultra Safe Nuclear Corporation of Seattle, Washington, issued Mar. 1, 2022, titled “Composite Moderator for Nuclear Reactor Systems,” the entirety of which is incorporated by reference herein.

Nuclear reactor system 100 can also be a terrestrial power system, such as a nuclear electric propulsion (NEP) system for fission surface power (FSP) system. NEP powers electric thrusters such as a Hall-effect thruster for robotic and human spacecraft. FSP provides power for planetary bodies such as the moon and Mars. In the NEP and FSP power applications, the nuclear reactor system 100 enabled with the ordered fuel particle packing 157 technology heats a working fluid (e.g., He, HeXe, Ne, CO₂) through a power conversion system (e.g., Brayton) to produce electricity. Moreover, in the NEP and FSP power applications, the nuclear reactor system 100 does not include a propellant, but rather includes a working fluid that passes through a reactor inlet when producing power. In the NEP and FSP power applications, the fuel elements 104A-N can be cooled via the reactor inlet working fluid (e.g., the flow coming out of a recuperator).

Utilizing the ordered fuel particle packing 157 technology described herein enables a nuclear reactor system 100 that is high-temperature, compact, accident tolerant, and operates safely and reliably throughout the lifetime of the nuclear reactor system 100. For example, the nuclear reactor core 101 can be within a small commercial fission power system for near term space operations, lunar landers, or a commercial fission power system for high-power spacecraft and large-scale surface operations, such as in-situ resource utilization.

Nuclear reactor core 101 includes an insulator element array 112 of insulator elements 102A-N and a moderator element array 113 of moderator elements 103A-N. Moderator elements 103A-N can be blocks or various other shapes formed of, for example, a low-temperature solid-phase moderator. However, moderator elements 103A-N are not limited to being a low-temperature moderator, and can be a high-temperature or moderate temperature moderator. Moderator elements 103A-N can include low density carbides, metal-carbides, metal-oxides, or a combination thereof. The moderator elements 103A-N can include any solid neutron-moderating materials, such as graphite; other forms of carbon such as industrial diamond or amorphous carbon, beryllium metal, beryllium oxide; beryllides, such as beryllium-zirconium; hydrides such as zirconium hydride or yttrium hydride; or compounds and composite materials containing neutron moderating materials, such as hydrides or beryllides in a high-temperature matrix such as MgO, SiC, or ZrC. Moderator elements 103A-N can include low density SiC, stabilized zirconium oxide, aluminum oxide, low density ZrC, low density carbon, or a combination thereof. Moderator elements 103A-N can also be formed of a low-temperature solid-phase moderator, including MgHₓ, YHₓ, ZrHₓ, CaHₓ, ZrOₓ, CaOₓ, BeOₓ, BeCₓ, Be, enriched boron carbide, ¹¹B₄C, CeHₓ, LiHₓ, or a combination thereof.

Insulator elements 102A-N can be formed of a high-temperature thermal insulator material with low thermal conductivity. The high-temperature thermal insulator material can include low density carbides, metal-carbides, metal-oxides, or a combination thereof. More specifically, the high-temperature thermal insulator material includes low density SiC, stabilized zirconium oxide, aluminum oxide, low density ZrC, low density carbon, or a combination thereof.

In this nuclear reactor system 100, the nuclear reactor 107 can include a plurality of control drums 115 and a reflector 140. For example, in an NTP, NEP, or FSP nuclear reactor system 100, the nuclear reactor 107 can include the plurality of control drums 115A-N that occupy a plurality of control drum channels 135A-N. Control drums 115A-N are rotated within the control drum channels 135A-N. The control drums 115A-N may laterally surround the fuel element array 114 of fuel elements 104A-N to change reactivity of the nuclear reactor core 101 by rotating the control drums 115A-N. As depicted, the control drums 115A-N reside on the perimeter or periphery of a pressure vessel 160 and are positioned circumferentially around the fuel elements 104A-N of the nuclear reactor core 101. Control drums 115A-N may be located in an area of an optional reflector 140, e.g., an outer reflector region immediately surrounding the nuclear reactor core 101, to selectively regulate the neutron population and nuclear reactor power level during operation.

For example, the control drums 115A-N can be a cylindrical shape and formed of both a reflector material 116 (e.g., beryllium (Be), beryllium oxide (BeO), BeSiC, BeMgO, Al₂O₃, etc.) on a first outer surface and an absorber material 117 on a second outer surface. The reflector material 116 and the absorber material 117 can be on opposing sides of the cylindrical shape, e.g., portions of an outer circumference, of the control drums 115A-N. The reflector material 116 can include a reflector substrate shaped as a cylinder or a truncated portion thereof. The absorber material 117 can include an absorber plate or an absorber coating. The absorber plate or the absorber coating are disposed on the reflector substrate to form the cylindrical shape of each of the control drums 115A-N. For example, the absorber plate or the absorber coating covers the reflector substrate formed of the reflector material to form the control drums 115A-N.

Rotating the depicted cylindrical-shaped control drums 115A-N changes proximity of the absorber material 117 (e.g., boron carbide, B₄C) of the control drums 115A-N to the nuclear reactor core 101 to alter the amount of neutron reflection. When the reflector material 116 is inwards facing towards the nuclear reactor core 101 and the absorber material 117 is outwards facing, neutrons are scattered back (reflected) into the nuclear reactor core 101 to cause more fissions and increase reactivity of the nuclear reactor core 101. When the absorber material 117 is inwards facing towards the nuclear reactor core 101 and the reflector material 116 is outwards facing, neutrons are absorbed and further fissions are stopped to decrease reactivity of the nuclear reactor core 101. In a terrestrial land application, the nuclear reactor core 101 may include control rods (not shown) composed of chemical elements such as boron, silver, indium, and cadmium that are capable of absorbing many neutrons without themselves fissioning.

Neutron reflector 140 (optional), can be filler elements disposed between outermost fuel elements 104A-N and control drums 115A-N as well as around control drums 115A-N. Reflector 140 can be formed of a moderator that is disposed between the outermost moderator elements 103A-N and an optional barrel (e.g., formed of beryllium).

The reflector 140 can include hexagonal or partially hexagonal shaped filler elements and can be formed of a neutron moderator (e.g., beryllium oxide, BeO). Although not required, nuclear reactor 107 can include the optional barrel (not shown) to surround the bundled collection that includes the insulator elements 102A-N, moderator elements 103A-N, and fuel elements 104A-N of the nuclear reactor core 101, as well as the reflector 140.

Pressure vessel 160 can be formed of aluminum alloy, carbon-composite, titanium alloy, a radiation resilient SiC composite, nickel based alloys (e.g., Inconel™ or Haynes™0), or a combination thereof. Pressure vessel 160 and the nuclear reactor core 101 can be comprised of other components, including cylinders, piping, and storage tanks that transfer a coolant, such as a propellant (e.g., hydrogen gas or liquid), that flows through the coolant channels 141A-N.

FIG. 2 is a zoomed in view of the nuclear reactor core 101 of FIG. 1 showing details of a single fuel element 104 that includes coolant channels 141A-N and fuel particle matrices 111A-N with the ordered fuel particle packing 157. In the depicted example, there is one fuel particle matrix 111A-N associated with each coolant channel 141A-N (one fuel particle matrix 111A-N per coolant channel 141A-N). Fuel element 104 is surrounded by an insulator element 102 which, in turn, is surrounded by a moderator element 103. In FIG. 2, fuel elements 104A-N are depicted as cylinders, insulator elements 102A-N are depicted as a cylindrical shaped tube or pipe, and the coolant channels 141A-N are depicted as cylinders. However, the fuel elements 104A-N, insulator elements 102A-N, and coolant channels 141A-N can be formed into a variety of shapes. In addition to being a circular or other round shape in two-dimensional space, the fuel elements 104A-N can be oval, square, rectangular, triangular, hexagonal, or another polygon shape. For example, the fuel elements 102A-N can be a polyhedron (e.g., a triangular prism or a cuboid) in three-dimensional space. In order to be disposed around the fuel elements 104A-N, the insulator elements 123A-N can be a shape that conforms to the shape of the fuel elements 104A-N.

Fuel element 104 includes an encapsulation matrix 152 and a plurality of coolant channels 141A-N formed in the encapsulation matrix 152. In a first example, the encapsulation matrix 152 includes graphite. In a second example, the encapsulation matrix 152 is a high-temperature matrix. The high-temperature matrix can include silicon carbide, zirconium carbide, titanium carbide, niobium carbide, tungsten, molybdenum, or a combination thereof.

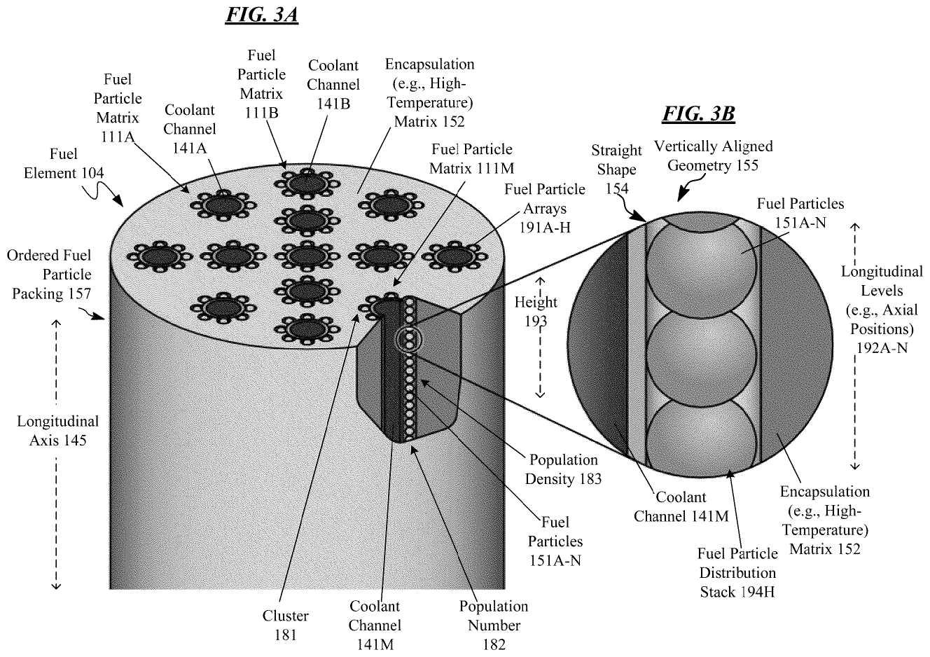

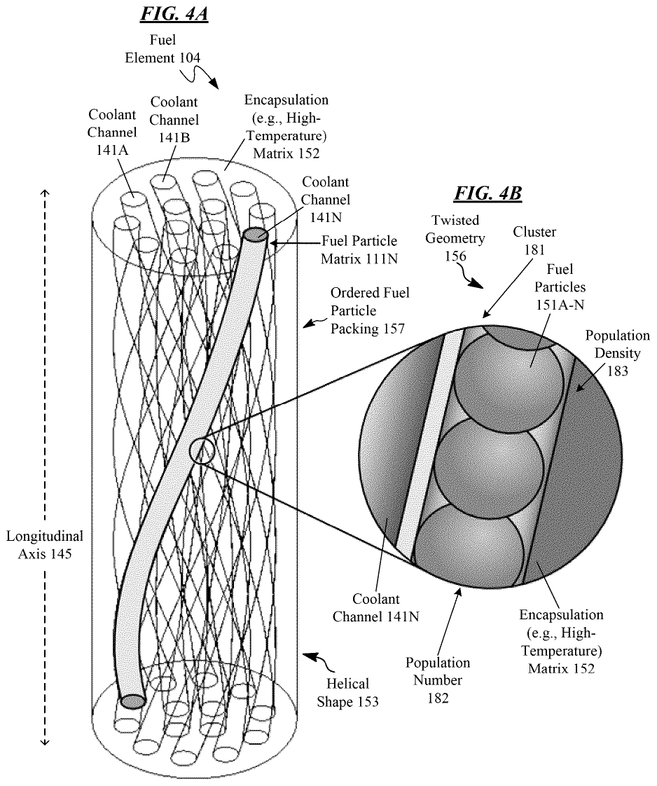

As further shown in FIGS. 3A-B and 4A-B, the ordered fuel particle packing 157 can include a variety of geometries, such as the vertically aligned geometry 155 and the twisted geometry 156. In FIGS. 3A-B, the ordered fuel particle packing 157 with a vertically aligned geometry 155 is depicted. In FIGS. 4A-B, the ordered fuel particle packing 157 with the twisted geometry 156 is shown.

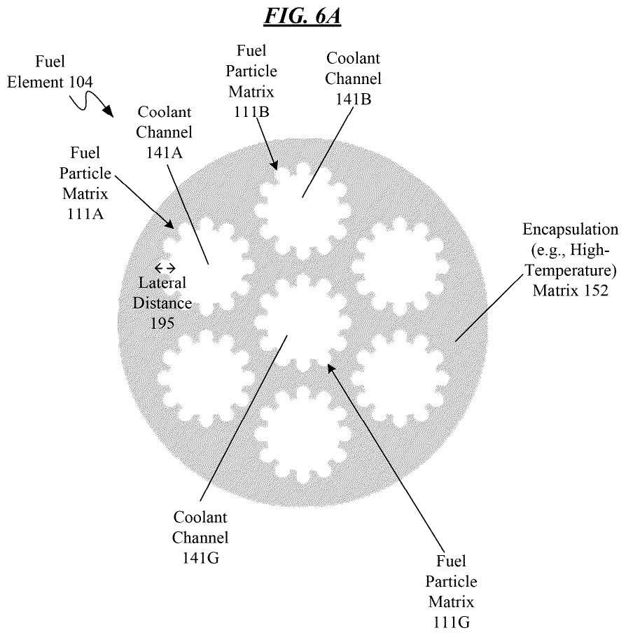

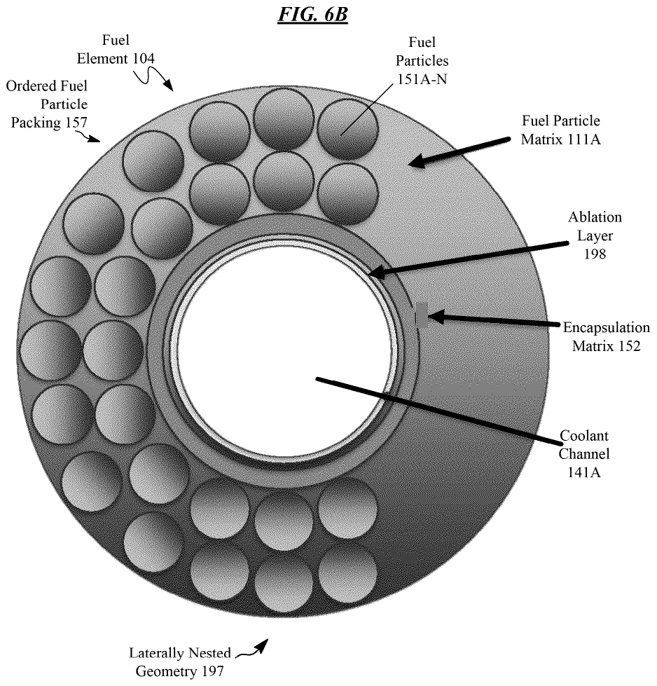

Referring back to FIG. 2, fuel element 104 further includes a plurality of fuel particle matrices 111A-N disposed within the encapsulation matrix 152. Each of the fuel particle matrices 111A-N is: ordered in a vertically aligned geometry 155 or a twisted geometry 156 to: (a) substantially laterally surround a contour of a respective coolant channel 141A-N, and (b) orient substantially longitudinally or substantially helically along the respective coolant channel 141A-N. In the example of FIG. 2, each of the fuel particle matrices 111A-N can be formed as a ring shape (e.g., annulus) to follow the contour (e.g., outline, periphery shape, profile, etc.) of the respective coolant channel 141A-N. Although a single ring is shown, the fuel particle matrices 111A-N can be formed as a multiple ring arrangement of fuel particles 151A-N, such as a double ring arrangement or other laterally nested geometry 197 (see FIG. 6B).

Each of the fuel particle matrices 111A-N includes a plurality of fuel particles 151A-N that are a cluster 181 around the respective coolant channel 141A-N. In total, thirty-seven fuel particle matrices 111A-N and thirty-seven coolant channels 141A-N per fuel element 104 are shown in FIGS. 1-2. However, the number of fuel particle matrices 111A-N can vary depending on the design of the nuclear reactor core 101.

Fuel element 104 includes coolant channels 141A-N formed therein to provide thermal contact between the coolant and the fuel particle matrices 111A-N. In the ordered fuel particle packing 157, the nuclear fuel in each of the fuel particles 151A-N of the fuel element 104 is moved as close as possible to the coolant channels 141A-N enabling ultra-high temperature reactor applications. Although the coolant channels 141A-N are depicted as cylinders, the coolant channels 141A-N can be formed into a variety of shapes. For example, the coolant channels 141A-N can be oval, square, rectangular, triangular, or another polygon shape. Because the fuel particle matrices 111A-N substantially laterally surround a contour of a respective coolant channel 141A-N, the fuel particle matrices 111A-N can mimic a periphery shape of the respective coolant channel 141A-N. Hence, the fuel particle matrices 111A-N can also be formed in a variety of shapes or patterns. For example, the fuel particle matrices 111A-N can be ring shaped (e.g., annularly arranged) as shown in FIG. 2; or oval, square, rectangular, triangular, or another polygon shape that can depend on the contour of the respective coolant channel 141A-N.

Coolant (e.g., propellant) can be a gas or a liquid, e.g., that transitions from a liquid to a gas state during a burn cycle of the nuclear reactor core 101 for thrust generation in an NTP nuclear reactor system 100. Hydrogen is an example coolant for an NTP nuclear reactor system 100. The coolant that flows through the coolant channels 141A-N can include helium, FLiBe molten salt formed of lithium fluoride (LiF), beryllium fluoride (BeF₂), sodium, He, HeXe, CO₂, neon, or HeN. In an NEP or FSP nuclear reactor 107, a working fluid, such as He, neon, HeXe, CO₂, etc. is circulated.

In the example of FIG. 2, the fuel particles 151A-N are coated fuel particles, such as tristructural-isotropic (TRISO) fuel particles. Alternatively or additionally, the fuel particles 151A-N can include bistructural-isotropic (BISO) fuel particles. In yet another implementation, the fuel particles 151A-N are comprised of a variation of TRISO known as TRIZO fuel particles. A TRIZO fuel particle replaces the silicon carbide layers of the TRISO fuel particle with zirconium carbide (ZrC). Alternatively, the TRIZO fuel particle includes the typical coatings of a TRISO fuel particle and an additional thin ZrC layer coating around the fuel kernel, which is then surrounded by the typical coatings of the TRISO fuel particle.

TRISO-like coatings may be simplified or eliminated depending on safety implications and manufacturing feasibility. Although the fuel particles 151A-N in the example include coated fuel particles, such as TRISO fuel particles, BISO fuel particles, or TRIZO fuel particles, the fuel particles 151A-N can include uncoated fuel particles.

Each of the TRISO fuel particles 151A-N can include a fuel kernel surrounded by a porous carbon buffer layer, an inner pyrolytic carbon layer, a binary carbide layer (e.g., ceramic layer of SiC or a refractory metal carbide layer), and an outer pyrolytic carbon layer. The refractory metal carbide layer of the TRISO fuel particles 151A-N can include at least one of titanium carbide (TiC), zirconium carbide (ZrC), niobium carbide (NbC), tantalum carbide, hafnium carbide, ZrC-ZrB₂ composite, ZrC-ZrB₂-SiC composite, or a combination thereof. The encapsulation matrix 152 can be formed of the same material as the binary carbide layer of the TRISO fuel particles 151A-N.

TRISO fuel particles 151A-N are designed not to crack due to the stresses or fission gas pressure at temperatures beyond 1,600 C., and therefore can contain the nuclear fuel within in the worst of accident scenarios. TRISO fuel particles 151A-N are designed for use in high-temperature gas-cooled reactors (HTGR) and to be operating at temperatures much higher than the temperatures of light water reactors. TRISO fuel particles 151A-N have extremely low failure below 1,500 C. Moreover, the presence of the encapsulation matrix 152 provides an additional robust barrier to radioactive product release.

A description of TRISO fuel particles dispersed in a silicon carbide matrix to form a cylindrical shaped nuclear fuel compact is provided in the following patents and publications of Ultra Safe Nuclear Corporation of Seattle, Washington: U.S. Pat. No. 9,299,464, issued Mar. 29, 2016, titled “Fully Ceramic Nuclear Fuel and Related Methods”; U.S. Pat. No. 10,032,528, issued Jul. 24, 2018, titled “Fully Ceramic Micro-encapsulated (FCM) fuel for CANDUs and Other Reactors”; U.S. Pat. No. 10,109,378, issued Oct. 23, 2018, titled “Method for Fabrication of Fully Ceramic Microencapsulation Nuclear Fuel”; U.S. Patent Nos. 9,620,248, issued Apr. 11, 2017 and 10,475,543, issued Nov. 12, 2019, titled “Dispersion Ceramic Micro-encapsulated (DCM) Nuclear Fuel and Related Methods”; U.S. Pat. No. 11,264,141, issued Mar. 1, 2022, titled “Composite Moderator for Nuclear Reactor Systems”; and U.S. Pat. No. 10,573,416, issued Feb. 25, 2020, titled “Nuclear Fuel Particle Having a Pressure Vessel Comprising Layers of Pyrolytic Graphite and Silicon Carbide,” the entireties of which are incorporated by reference herein. As described in those Ultra Safe Nuclear Corporation patents, the nuclear fuel can include a cylindrical fuel compact or pellet comprised of TRISO fuel particles embedded inside a silicon carbide matrix to create a cylindrical shaped nuclear fuel compact. A description of TRISO, BISO, or TRIZO fuel particles dispersed in a zirconium carbide matrix to form a cylindrical shaped nuclear fuel compact is provided in U.S. Pat. No. 11,189,383, to Ultra Safe Nuclear Corporation of Seattle, Washington, issued Nov. 30, 2021, titled “Processing Ultra High Temperature Zirconium Carbide Microencapsulated Nuclear Fuel,” the entirety of which is incorporated by reference herein.

The fuel particles 151A-N are formed of an internal fuel kernel, and at least one coating layer. The fuel kernel can be formed of uranium carbide (UCₓ), thorium dioxide (ThO₂), uranium oxides (e.g., UO₂, UCO, Stabilized UO₂), uranium mononitride (UN), uranium-moly bdenum (UMo) alloy, uranium-zirconium (UZr) alloy, triuranium disilicate (U₃Si_{2,5}), uranium boride (UB), uranium diboroide (UB₂), uranium gadolinium carbide nitride (UGdCN), uranium zirconium carbide nitride (UZrCN), uranium zirconium carbide (UZrC), uranium tricarbide (UC₃), uranium zirconium niobium carbide (UZrNbC), molten fuel in a carbon kernel (i.e., infiltrated kernel), composites (e.g., uranium-dioxide-molybdenum (UO₂Mo) alloy, uranium nitride/triuranium disilicate (UN/U₃Si₂), or triuranium disilicate/uranium diboride (U₃Si₂/UB₂)), dopants (e.g. chromium oxide (Cr₂O₃)), other fissile and fertile fuels, or any combination thereof. The kernel can be spherical, a composite, or formed of nanofibers. The at least one coating layer of the fuel particles 151A-N may be formed of pyridine carbide (PyC), silicon carbide (SiC), zirconium carbide (ZrC), zirconium diboride (ZrB₂), niobium carbide (NbC), titanium carbide (TiC), tantalum carbide (TaC), titanium nitride (TiN), boron carbide (B₄C), beta-decayed silicon nitride (β-Si₃N₄), SiAlON ceramics, or any combination thereof.

In a more specific example, each of the fuel particles 151A-N can include a porous carbon buffer layer surrounding the internal kernel, an inner pyrolytic carbon layer, a binary carbide layer (e.g., ceramic layer of SiC or a refractory metal carbide layer), and an outer pyrolytic carbon layer. The refractory metal carbide layer of the fuel particles 151A-N can include at least one of titanium carbide (TiC), zirconium carbide (ZrC), niobium carbide (NbC), tantalum carbide, hafnium carbide, ZrC-ZrB₂ composite, ZrC-ZrB₂-SiC composite, or a combination thereof. The other layers of the fuel particles 151A-N can be formed of the same material as the at least one coating layer mentioned above.

Fuel particles 151A-N of the fuel element 104 can be similar in size or of substantially the same size. Alternatively, the fuel particles 151A-N can be of varying particle sizes to improve a packing fraction in the fuel element 104. In some examples, the fuel particles 151A-N can be between approximately 100 and 2,000 microns, with multiple size populations (e.g., 100 microns, 700 microns, 2,000 microns, etc.) to enhance the packing fraction of fuel particles 151A-N.

High-temperature matrix 152 may be formed of silicon carbide (SiC), which has excellent chemical stability in the presence of air and water in repository conditions, but also at temperatures of a nuclear reactor core 101. If SiC is not sufficiently high performance, another high-temperature matrix 152 material such as zirconium carbide (ZrC) can also be used. Some examples of high-temperature matrix 152 materials include silicon carbide (SiC), zirconium carbide (ZrC), magnesium oxide (MgO), tungsten (W), molybdenum (Mo), zirconium boride (ZrB₂), NbC, TiC, TaC, TiN, zirconium (Zr), TaC, B₄C, β-Si₃N₄, SiAlON ceramics, aluminum nitride (AlN), aluminum oxide (Al₂O₃), stainless steel, or any combination thereof.

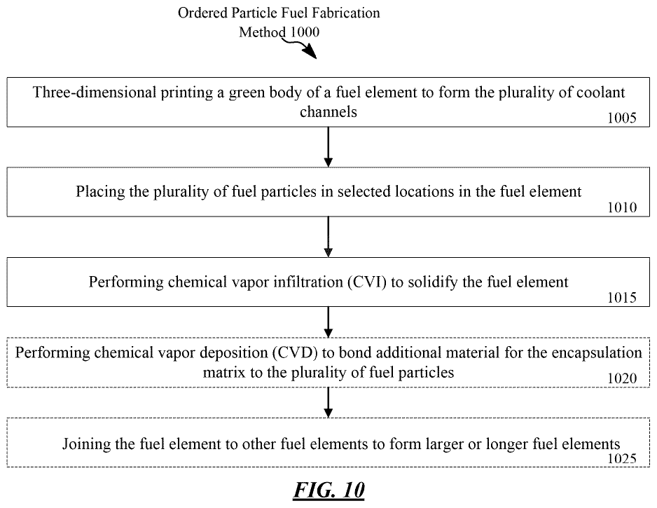

Fuel element 104 implements the ordered fuel particle packing 157 to provide material barriers to the transport of fission products and fissile materials. The fuel element 104 is arranged in a manner to ensure that each discrete element of fuel (fuel particles 151A-N) is maintained at a constant, predictable, and minimum distance from the coolant (e.g., propellant). Different temperature profiles can create differential thermal stresses in a nuclear reactor core 101, which can result in material cracks. However, the ordered fuel particle packing 157 can prevent the material cracks from transmitting from the fuel material through surface walls. As described in FIG. 10, fuel elements 104A-N can be manufactured using an ordered particle fuel fabrication method 1000 that can implement additive manufacturing and additional processing steps.

The precise dimensions and arrangement of the ordered fuel particle packing 157 around the coolant channels 141A-N (e.g., heat transfer pipes) can be variable to achieve criticality for a given nuclear design goal and design of the nuclear reactor 107. The annular placement of the fuel particle matrices 111A-N around the coolant channels 141A-N or propellant flow surface can be designed to minimize the thermal gradient between the nuclear fuel in the fuel particles 151A-N by minimizing the heat transfer resistance between the center of the nuclear fuel to achieve criticality for the given design criteria. Ordered fuel particle packing 157 allows the nuclear fuel to operate as close as possible to the maximum possible temperature it can survive during normal operation, enabling ultra-high temperature reactor applications of the nuclear reactor 107.

FIG. 3A is a cutaway view of a single fuel element 104 similar to that of FIG. 2 that depicts a fuel particle matrix 111M with the ordered fuel particle packing 157 in a vertically aligned geometry 155. In FIG. 3A, the fuel element 104 includes thirteen fuel particle matrices 111A-M and thirteen coolant channels 141A-M; however the precise number can vary depending on the nuclear reactor core 101. Also shown in FIG. 3A is an encircled detail area to show context for a zoomed in view of FIG. 3B.

FIG. 3B is the zoomed in view of the encircled detail area of the fuel element 104 of FIG. 3A with the fuel particle matrix 111M ordered in the vertically aligned geometry 155. As shown in FIGS. 3A-B, each of the fuel particle matrices 111A-M is in the vertically aligned geometry 155. Coolant channels 141A-M are formed as openings with a straight shape 154 to accommodate the fuel particle matrices 111A-M in the vertically aligned geometry 155. Each of the fuel particle matrices 111A-M includes a plurality of fuel particle arrays 191A-H. In the example of FIG. 3A, eight fuel particle arrays 191A-H per fuel particle matrix 111A-H are shown, but the number can vary depending on the implementation of the fuel element 104. Each of the fuel particle arrays 191A-H is positioned at varying longitudinal levels (e.g., axial positions) 192A-N along a height 193 of the respective coolant channel 141A-N. Hence, each of the fuel particle arrays 191A-H is stacked to form a respective fuel particle distribution stack 194A-H extending substantially longitudinally within the encapsulation matrix 152. In the example of FIGS. 3A-B, there are eight fuel particle distributions stacks 194A-H (one per fuel particle array 191A-H); however, the number can vary.

FIG. 4A is a cutaway view of a single fuel element 104 similar to that of FIG. 2 that depicts a fuel particle matrix 111N with the ordered fuel particle packing 157 in a twisted geometry 156. In FIG. 4A, the fuel element 104 includes fourteen fuel particle matrices 111A-N and fourteen coolant channels 141A-N. However, the precise number can vary depending on the nuclear reactor core 101. Also shown in FIG. 4A is an encircled detail area to show context for a zoomed in view of FIG. 4B.

FIG. 4B is the zoomed in view of the encircled detail area of the fuel element 104 of FIG. 4A with the fuel particle matrix 111N ordered in the twisted geometry 156. As shown in FIGS. 4A-B, each of the fuel particle matrices 111A-N is in the twisted geometry 156. To accommodate the fuel particle matrices 111A-N in the twisted geometry 156, the coolant channels 141A-N have a helical shape 153. Each of the plurality of fuel particles 151A-N helically wind around the respective coolant channel 141A-N. Hence, each of the fuel particle matrices 111A-N spirals around the respective coolant channel 141A-N.

In both FIGS. 3A-B and 4A-B, each of the plurality of fuel particles 151A-N can be substantially uniform in population number 182. For example, each of the plurality of fuel particles 151A-N are substantially uniform in population density 183 in the cluster 181 around the respective coolant channel 141A-N. The fuel particles 151A-N of each fuel particle matrix 111A-N may appear non-uniformly distributed on a microscopic scale. But when aggregated as a whole and viewed on a macroscopic scale, the aggregation of the plurality of fuel particles 151A-N of each fuel particle matrix 111A-N is perceived as being packed in an ordered manner to an observer. Hence, the fuel element 104 has an ordered fuel particle packing 157.

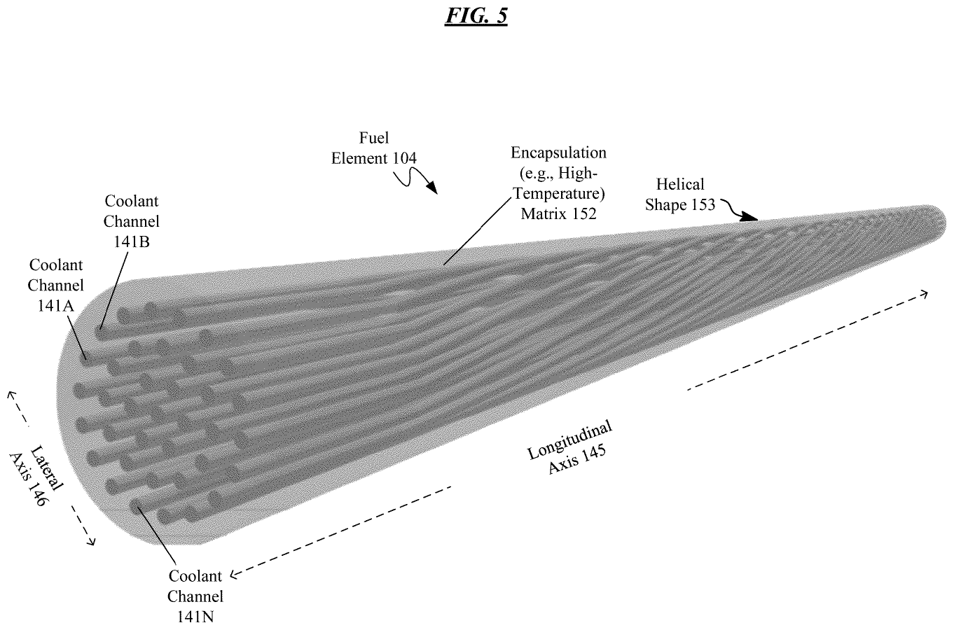

FIG. 5 is an isometric view of a single fuel element 104 similar to that of FIGS. 4A-B and showing details of the coolant channels 141A-N helically winding around a longitudinal axis 145. Fuel element 104 includes the plurality of coolant channels 141A-N formed therein with a helical shape 153. Each of the coolant channels 141A-N rotate around the longitudinal axis 145 of the fuel element 104 such that a lateral position of a respective coolant channel 141A-N on a lateral axis 146 changes at different longitudinal levels (e.g., axial positions) 192A-N along a longitudinal axis 145 of the fuel element 104. The changing lateral position of the respective coolant channel 141A-N forms at least one twist along the longitudinal axis 145.

Like FIGS. 1-2, in total, thirty-seven coolant channels 141A-N per fuel element 104 are shown in FIG. 5. However, the number of coolant channels 141A-N can vary depending on the implementation of the fuel element 104, such as the number of fuel particle matrices 111A-N.

FIG. 6A is a cross-sectional view of a single fuel element 104 similar to that of FIGS. 2A-B and 3A-B showing details of coolant channels 141A-G and fuel particle matrices 111A-G. In FIG. 6A, the fuel element 104 includes seven fuel particle matrices 111A-G and seven coolant channels 141A-G. However, the precise number can vary depending on the nuclear reactor core 101. Coolant channels 141A-N are openings, passages, apertures, or holes to allow the coolant to pass through the fuel element 104 and into a thrust chamber (not shown) for propulsion, for example.

In the ordered fuel particle packing 157, each of the fuel particles 151A-N of the fuel particle matrix 111A can be at approximately the same lateral distance 195 to the coolant channel 141A. Moreover, each of the fuel particle matrices 111A-N can be at approximately the same lateral distance 195 to the respective coolant channel 141A-N. These configurations optimize heat transfer by minimizing the transport distance of heat generated to the coolant to improve lifetime and fission product retention. For example, both the vertically aligned geometry 155 of FIGS. 3A-B and the twisted geometry 156 of FIGS. 4A-B can implement such configurations.

FIG. 6B is a cross-sectional view of a fuel element 104 like that of FIGS. 3A-B and 4A-B with an ordered fuel particle packing 157 in which the fuel particle matrix 111A has a laterally nested geometry 197. In the example of FIG. 6B, the plurality of fuel particles 151A-N of the fuel particle matrix 111A form the laterally nested geometry 197, which is a double ring. However, the laterally nested geometry 197 can be three or more rings, or other shape, such as a polygon, oval, etc. that follows the contour of the coolant channel 141A. In FIG. 6B, the fuel element 104 also includes an ablation layer 198 that is located between the coolant channel 141A and the fuel particle matrix 111A. Ablation layer 198 provides ablation and thermal resistance and can be formed of any suitable material, such as HfCZrN, for example. Fuel particles 151A-N can be in good thermal contact with the ablation layer 198. A thickness of the ablation layer 198 can vary according to an axial ablation rate and nucleotide retention needs of the nuclear reactor core 101.

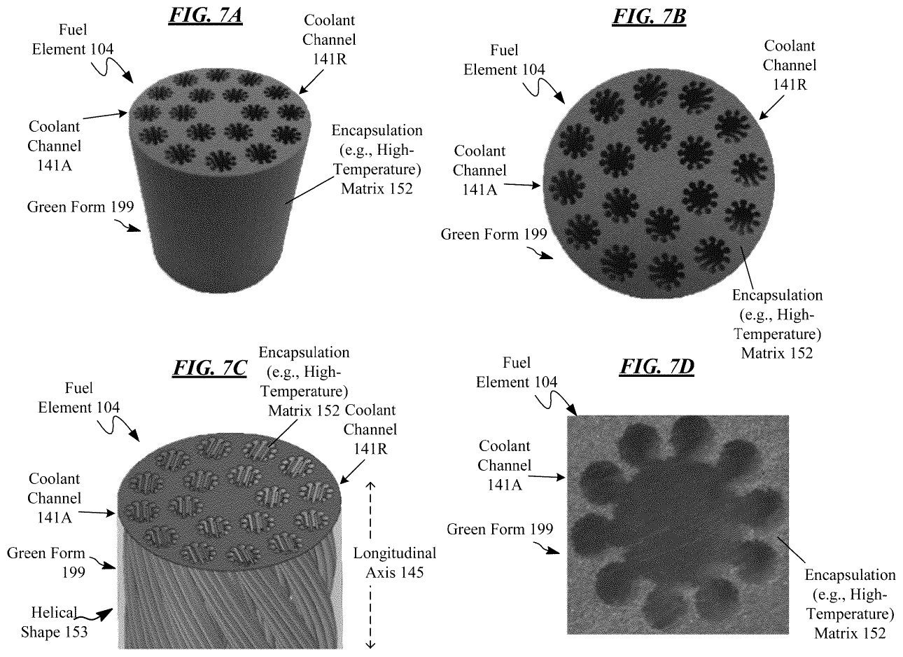

FIG. 7A is an isometric view of a green form (e.g., green body) 199 of a single fuel element 104 that includes coolant channels 141A-R. FIG. 7B is a top view of the green form 199 of FIG. 7A showing details of the coolant channels 141A-R. FIG. 7C is a cutaway view of the green form 199 of FIGS. 7A-B showing details of the green form 199 with a twisted geometry 156. In FIGS. 7A-C, the fuel element 104 includes eighteen fuel particle matrices 111A-R and eighteen coolant channels 141A-R. FIG. 7D is a top view of a single coolant channel 141A of the green form 199 of FIGS. 7A-C.

As shown in FIG. 7C, coolant channels 141A-N formed in the encapsulation matrix 152 of the green form 199 can be helical shaped openings. The helical shape 153 of the coolant channels 141A-N can wind around the longitudinal axis 145 of the fuel element 104 to accommodate fuel particle matrices 111A-N in the twisted geometry 156 (see FIGS. 4A-B). Alternatively, coolant channels 141A-N formed in the encapsulation matrix 152 of the green form 199 can be vertical openings with a straight shape 154 that align with the longitudinal axis 145 of the fuel element 104 to accommodate fuel particle matrices 111A-N in the vertically aligned geometry 155 (see FIGS. 3A-B).

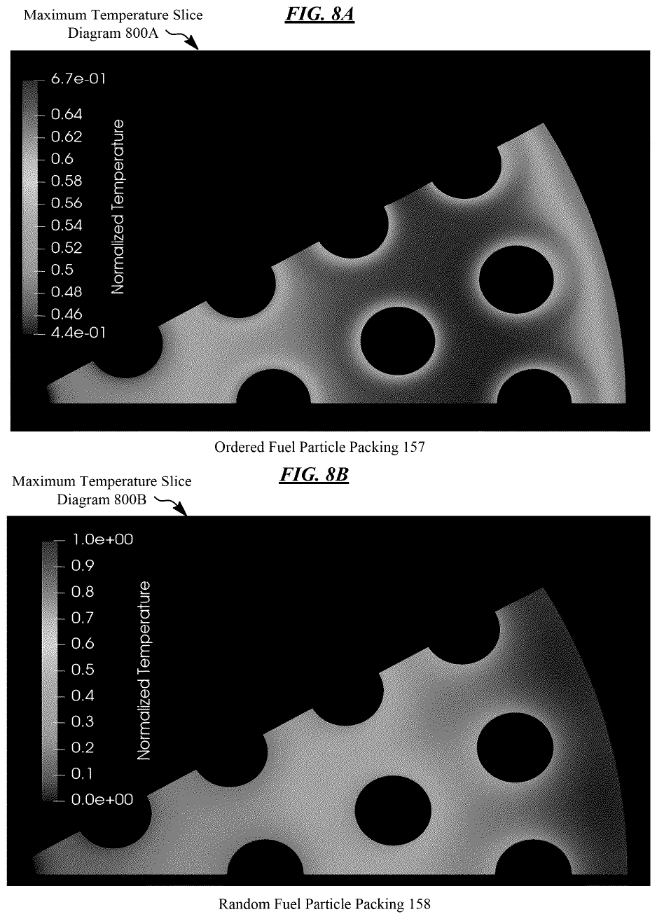

FIG. 8A is a diagram of the maximum temperature slice 800A for a fuel element 104 with an ordered fuel particle packing 157. FIG. 8B is a diagram of the maximum temperature slice 800B for a fuel element 104 with a random fuel particle packing 158. As shown, the ordered fuel particle fuel packing 157 reduces the maximum temperature substantially—approximately an order of magnitude.

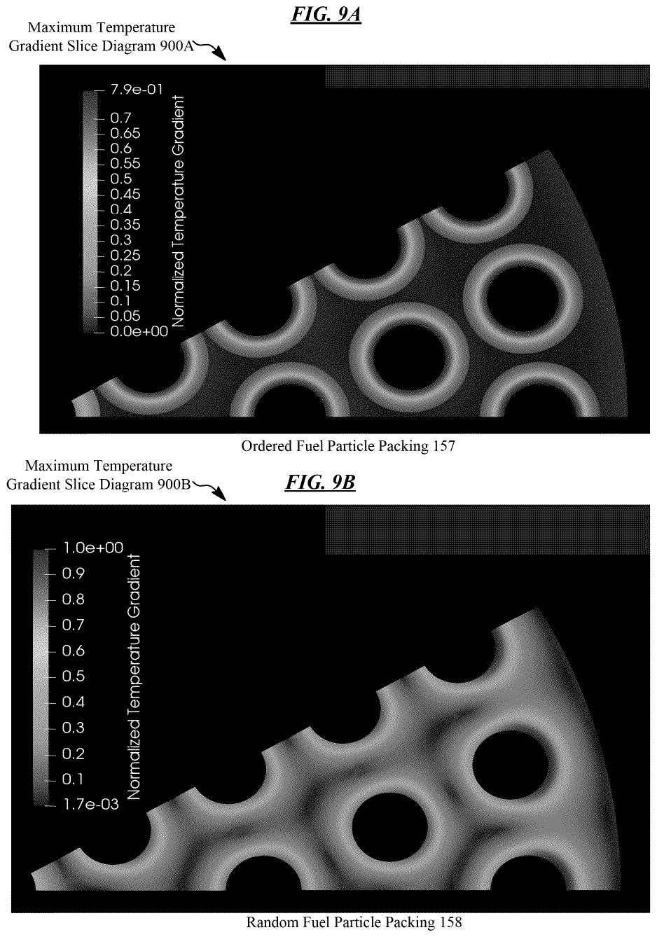

FIG. 9A is a diagram of the maximum temperature gradient slice 900A for a fuel element 104 with an ordered fuel particle packing 157. FIG. 9B is a diagram of the maximum temperature gradient slice 900B for a fuel element 104 with a random fuel particle packing 158. As depicted, the ordered fuel particle packing 157 reduces the maximum temperature gradient and increases the uniformity of the gradient by approximately an order of magnitude.

Hence, FIGS. 8A-B and 9A-B illustrate analyses of normalized maximum temperature 800A-B and gradient data 900A-B that compare ordered fuel particle packing 157 with random fuel particle packing 158. The analyses of FIGS. 8A-B and 9A-B were performed with TRICORDER. The actual number of layers of fuel particles 151A-N in the analyses can be considered a subset of the ordered particle fuel case at this level. To approximate a fuel element 104 with the random fuel particle packing 158, the analyses for the diagrams 800B, 900B smeared power density over a microtube and inner fuel block. The analyses kept in-element peaking and assume no orificing of coolant channels 141A-N. The results shown in diagrams 800A-B, 900A-B were normalized based on the following equation: (value−minimum(value))/(maximum(value)−minimum(value)). The unexpected result shown in FIGS. 8A-B and 9A-B is the magnitude of temperature reduction for the ordered fuel particle packing 157 versus the random fuel particle packing 158.

FIG. 10 is a flowchart of an ordered particle fuel fabrication method 1000 for a fuel element 104. Ordered particle fuel fabrication method 1000 can be used to form the fuel element 104 with an ordered fuel particle packing 157, such as with fuel particle matrices 111A-N ordered in a vertically aligned geometry 155 (see FIGS. 3A-B) or a twisted geometry 156 (see FIGS. 4A-B).

Generally, the manufacturing process for the fuel element 104 comprises several steps and different technologies including additive manufacturing, chemical vapor infiltration (CVI), chemical vapor deposition (CVD), and fuel particles 151A-N (e.g., particle-based nuclear fuel). A green body 199 of the fuel element 104 (see FIGS. 7A-D) typically undergoes a CVI step 1015 after the printing step 1005, which solidifies green body 199 so that the green body 199 may serve as the primary structure to support the fuel particles 151A-N. The green body 199 can be made of the encapsulation matrix 152, such as a ceramic material capable of withstanding very high temperatures without failure. Placement of the fuel particles 151A-N in the fuel element 104 (step 1010) occurs during one of the four following stages: (1) while the green body 199 is being printed (step 1005); (2) after the green body 199 has been printed but before the CVI step 1015; (3) after an initial partial-CVI step 1015, but before completion of the CVI step 1015, or (4) after completion of the CVI step 1015.

Beginning in step 1005, the ordered particle fuel fabrication method 1000 includes three-dimensional printing a green body 199 (see FIGS. 7A-D) of the fuel element 104 to form the plurality of coolant channels 141A-N. This initial step 1005 uses additive manufacturing to print the green body 199 of the fuel element 104. For example, additive manufacturing can use binder jet printing for ceramics, laser-based system manufacturing for metals and ceramics, etc. As outlined below, additional processing steps and inclusion of fuel particles 151A-N are applied prior to completion.

Continuing to step 1010, the ordered particle fuel fabrication method 1000 further includes placing the plurality of fuel particles 151A-N in selected locations in the fuel element 104. Generally, the step 1010 of placing the plurality of fuel particles 151A-N in the fuel element 104 includes adding the plurality of fuel particles 151A-N to the fuel element 104 during or after the step 1005 of three-dimensional printing the green body 199 of the fuel element 104. However, the plurality of fuel particles 151A-N can be added at more stages as discussed in step 1010 below.

The step 1010 of placing the plurality of fuel particles 151A-N in the fuel element 104 can include depositing each of the plurality of fuel particles matrices 111A-N around the respective coolant channel 141A-N. For example, the step of depositing each of the plurality of fuel particle matrices 111A-N can include loading the plurality of fuel particles 151A-N of each of the fuel particle matrices 111A-N around the respective coolant channel 141A-N at varying longitudinal levels 192A-N. Such a loading of the fuel particles 151A-N is depicted in the vertically aligned geometry 155 of FIGS. 3A-B. Alternatively, plurality of fuel particles 151A-N of each of the fuel particle matrices 111A-N can be loaded in the twisted geometry 156 shown in FIGS. 4A-B

Moving to step 1015, the ordered particle fuel fabrication method 1000 further includes performing chemical vapor infiltration (CVI) to solidify the fuel element 104. The step 1010 of placing the plurality of fuel particles 151A-N in the fuel element 104 includes adding the plurality of fuel particles 151A-N to the fuel element 104: (1) during the step 1005 of three-dimensional printing the green body 199 of the fuel element 104; (2) after the step 1005 of three-dimensional printing the green body 199 of the fuel element 104; (3) after partial completion of the step 1015 of performing chemical vapor infiltration; (4) after completion of the step 1015 of performing chemical vapor infiltration; or (5) a combination thereof.

Depending on the requirements for the fuel element 104, additional steps may be implemented prior to completion. These optional steps include steps 1020 and 1025. Proceeding to optional step 1020, the ordered particle fuel fabrication method 1000 further includes performing chemical vapor deposition (CVD) to bond additional material for the encapsulation matrix 152 to the plurality of fuel particles 151A-N. The additional material for the encapsulation matrix 152 bonds to the fuel particles 151A-N and the fuel element 104 to provide additional protection to the fuel particles 151A-N against chemical or mechanical degradation. Alternatively or additionally, bonding techniques, threaded caps, etc. can deposit the additional material for the encapsulation matrix 152 to form a seal.

Finishing now in optional step 1025, the ordered particle fuel fabrication method 1000 further includes joining the fuel element 104 to other fuel elements 104B-N to form larger or longer fuel elements. Hence, after completion, an individual fuel element 104 may be joined to form larger or longer fuel elements as needed for the selected use of the fuel.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,”“containing,” “contain,” “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best geometry and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A fuel element, comprising:
an encapsulation matrix;
a plurality of coolant channels formed in the encapsulation matrix; and
a plurality of fuel particle matrices disposed within the encapsulation matrix;
wherein each of the fuel particle matrices is:
ordered in a vertically aligned geometry or a twisted geometry to: (a) substantially laterally surround a contour of a respective coolant channel, and (b) orient substantially longitudinally or substantially helically along the respective coolant channel.

2. The fuel element of claim 2, wherein:
each of the fuel particle matrices includes a plurality of fuel particles that are a cluster around the respective coolant channel.

3. The fuel element of claim 2, wherein:
each of the fuel particle matrices is in the twisted geometry; and
each of the plurality of fuel particles helically wind around the respective coolant channel.

4. The fuel element of claim 2, wherein:
each of the plurality of fuel particles are substantially uniform in population number.

5. The fuel element of claim 2, wherein:
each of the plurality of fuel particles are substantially uniform in population density in the cluster around the respective coolant channel.

6. The fuel element of claim 1, wherein:
each of the fuel particle matrices is in the vertically aligned geometry;
each of the fuel particle matrices includes a plurality of fuel particle arrays; and
each of the fuel particle arrays is positioned at varying longitudinal levels along a height of the respective coolant channel.

7. The fuel element of claim 6, wherein:
each of the fuel particle arrays is stacked to form a respective fuel particle distribution stack extending substantially longitudinally within the encapsulation matrix.

8. The fuel element of claim 1, wherein:
each of the fuel particle matrices is in the twisted geometry; and
each of the fuel particle matrices spirals around the respective coolant channel.

9. The fuel element of claim 1, wherein:
the encapsulation matrix includes graphite.

10. The fuel element of claim 1, wherein:
the encapsulation matrix is a high-temperature matrix; and
the high-temperature matrix includes silicon carbide, zirconium carbide, titanium carbide, niobium carbide, tungsten, molybdenum, or a combination thereof.

11. The fuel element of claim 1, wherein:
the plurality of fuel particles include coated fuel particles.

12. The fuel element of claim 11, wherein:
the coated fuel particles include tristructural-isotropic (TRISO) fuel particles, bistructural-isotropic (BISO) fuel particles, or TRIZO fuel particles.

13. A fabrication method for the fuel element of claim 2, comprising steps of:
three-dimensional printing a green body of the fuel element to form the plurality of coolant channels; and
placing the plurality of fuel particles in selected locations in the fuel element.

14. A fabrication method for the fuel element of claim 13, wherein the step of placing the plurality of fuel particles in the fuel element includes:
depositing each of the plurality of fuel particles matrices around the respective coolant channel.

15. The fabrication method of claim 14, wherein the step of depositing each of the plurality of fuel particle matrices includes:
loading the plurality of fuel particles of each of the fuel particle matrices around the respective coolant channel at varying longitudinal levels.

16. The fabrication method for the fuel element of claim 13, wherein the step of placing the plurality of fuel particles in the fuel element includes:
adding the plurality of fuel particles to the fuel element during or after the step of three-dimensional printing the green body of the fuel element.

17. The fabrication method for the fuel element of claim 13, further comprising. performing chemical vapor infiltration (CVI) to solidify the fuel element.

18. The fabrication method for the fuel element of claim 17, wherein the step of placing the plurality of fuel particles in the fuel element includes adding the plurality of fuel particles to the fuel element:
(1) during the step of three-dimensional printing the green body of the fuel element;
(2) after the step of three-dimensional printing the green body of the fuel element;
(3) after partial completion of the step of performing chemical vapor infiltration;
(4) after completion of the step of performing chemical vapor infiltration; or
(5) a combination thereof.

19. The fabrication method for the fuel element of claim 13, further comprising.
performing chemical vapor deposition (CVD) to bond additional material for the encapsulation matrix to the plurality of fuel particles.

20. The fabrication method for the fuel element of claim 13, further comprising. joining the fuel element to other fuel elements to form larger or longer fuel elements.
